(19) United States
(12) Patent Application Publication
(10) Pub. No.: US 2024/0109405 A1
(43) Pub. Date: Apr. 4, 2024

(54) GLASS RUN

(71) Applicant: KINUGAWA RUBBER IND. CO., LTD., Chiba-shi (JP)

(72) Inventor: Shouya YAJIMA, Chiba-shi (JP)

(73) Assignee: KINUGAWA RUBBER IND. CO., LTD., Chiba-shi (JP)

(21) Appl. No.: 18/479,166

(22) Filed: Oct. 2, 2023

(30) Foreign Application Priority Data
Oct. 4, 2022 (JP) 2022-159894

(51) Int. Cl. B60J 10/76; B60J 10/27

(52) U.S. Cl. CPC B60J 10/76; B60J 10/27

(57) ABSTRACT

Glass run has bottom wall 11, interior-side and exterior-side side walls 13, 12 provided at both end edges of bottom wall 11, interior-side sealing lips 18, 19 provided on inner side surface of interior-side side wall 13 and obliquely protruding toward exterior-side side wall 12, and exterior-side sealing lip 16 provided on inner side surface of exterior-side side wall 12 and obliquely protruding toward interior-side side wall 13. Sealing lips 18, 19, 16 are formed linearly toward exterior-side side wall 12 and interior-side side wall 13 respectively. Arc-shaped top end surfaces 18c, 19c, 16c of top end portions of sealing lips 18, 19, 16 can slide on both side surfaces of door glass 4 in a line-contact state. Notch portions 20, 21, 17 that allow sealing lips 18, 19, 16 to fall down to respective directions of inner side surfaces of interior-side and exterior-side side walls 13, 12 are formed.

### BACKGROUND OF THE INVENTION

The present invention relates to an improved technique of a glass run which is fixed to, for example, an inner peripheral portion of a door panel (a sash) of a door for opening and closing an opening of a vehicle body of a vehicle and which guides a door glass with the door glass being in sliding contact with the glass run.

As is well known, this kind of conventional glass run is disclosed in the following Patent Document 1.

This glass run 30 is fixed to a door body or a door sash of a vehicle door. As shown in FIG. 12, the glass run 30 has a bottom wall 31, an exterior-side side wall 32 and an interior-side side wall 33 which extend from both end edges, in an exterior-to-interior width direction (simply, referred to as a vehicle width direction or a width direction), of the bottom wall 31 at substantially right angles to the bottom wall 31. The glass run 30 is formed so as to have a substantially channel shape in cross section with the glass run 30 fitted into and held by the door sash by being pressed or squeezed into an inside of the door sash from the bottom wall 31 side. The both exterior-side and interior-side side walls 32 and 33 are provided, at lower end portions thereof, with one exterior-side sealing lip 35 and one interior-side sealing lip 36 respectively which protrude and extend toward an inside of a channel-shaped space so as to face each other and which elastically contact respective side surfaces of a door glass 34 and seal gaps between the door glass 34 and the sealing lips 35 and

Further, the bottom wall 31 is provided, at an inner bottom surface 31a thereof, with a guide lip 37 which protrudes from the inner bottom surface 31a and whose top end portion 37a elastically contacts an interior-side side surface 34a of a top end portion of the door glass 34. This guide lip 37 is curved and formed into a substantially S-shape in cross section, and arranged so that a center line X of a base portion 37b, at the bottom wall 31 side, of the guide lip 37 is located at an exterior side with respect to a center line Y of the door glass 34. With this, the guide lip 37 is shaped so that the guide lip 37 as a whole is easily elastically deformed to a direction of the center line Y of the door glass 34. Therefore, the top end portion 37a of the guide lip 37 can elastically contact the interior-side side surface 34a of the top end portion of the door glass 34 with moderate force, thereby suppressing a rattling sound of the door glass 34 due to shake of the door glass 34 when closing the door in a half-open state of the door glass 34 while maintaining a good sliding characteristic of the door glass 34.

### CITATION LIST

Patent Document 1: Japanese Unexamined Patent Application Publication No. 2007-008372 (FIG. 4)

Patent Document 2: Japanese Unexamined Patent Application Publication No. 2021-024388

### SUMMARY OF THE INVENTION

In the case of the glass run 30 disclosed in Patent Document 1, however, although the glass run 30 is structured so that the rattling sound of the door glass 34 when closing the door in the half-open state of the door glass 34 is prevented by providing the guide lip 37, since the guide lip 37 is merely formed on the inner bottom surface 31a of the bottom wall 31 so as to protrude from the inner bottom surface 31a, the guide lip 37 tends to deform or curve in exterior and interior directions with the base portion 37b being a center. Because of this, a reaction force of the door glass 34 especially in a vehicle interior direction when closing the door cannot be effectively suppressed, and the occurrence of the rattle cannot be sufficiently suppressed. Further, since only one interior-side sealing lip 36 of the interior-side side wall 33 is provided, it is not possible to sufficiently suppress the reaction force of the door glass 34 in the vehicle interior direction when closing the door.

Therefore, it is conceivable that, like a glass run disclosed in Patent Document 2, by providing two interior-side sealing lips at a top end portion of the interior-side side wall and on an inner surface of the interior-side side wall, a force suppressing the reaction force of the door glass in the vehicle interior direction when closing the door will be increased then the occurrence of the rattle of the door glass will be suppressed.

However, these two interior-side sealing lips are arranged so as to slide in surface-contact with the side surface of the door glass while being deformed with respect to the side surface of the door glass when the door glass moves up and down. Because of this, a sliding friction drag (or a frictional resistance) between each interior-side sealing lip and the side surface of the door glass becomes large, then a technical problem of failing to obtain a smooth sliding characteristic (a smooth ascent-descent characteristic) of the door glass arises.

The present invention was made in view of the above technical problem occurring in the conventional glass run. An object of the present invention is therefore to provide a glass run that is capable of securing the smooth sliding characteristic (the smooth ascent-descent characteristic) of the door glass while suppressing the rattling sound (the rattle) caused by shake or vibration of the door glass when closing the door or during travel at high speed in a state in which the door glass is slightly open.

According to one aspect of the present invention, a glass run comprises: a bottom wall; an interior-side side wall and an exterior-side side wall provided at both end edges in a wide direction of the bottom wall; at least two interior-side sealing lips provided on an inner side surface of the interior-side side wall and obliquely protruding toward the exterior-side side wall; and an exterior-side sealing lip provided on an inner side surface of the exterior-side side wall and obliquely protruding toward the interior-side side wall, wherein both side surfaces of a door glass, which comes into the glass run toward the bottom wall, are supported in a sliding-contact state by top end portions of the interior-side sealing lips and a top end portion of the exterior-side sealing lip, the interior-side sealing lips and the exterior-side sealing lip are formed linearly toward the exterior-side side wall and the interior-side side wall respectively, top end surfaces, each of which is formed into an arc shape in cross section, of the top end portions of the interior-side sealing lips and the exterior-side sealing lip can slide on the both side surfaces of the door glass in a line-contact state, and the interior-side sealing lips and the exterior-side sealing lip are provided, at base end portions thereof connected to the interior-side side wall and the exterior-side side wall respectively, with respective thinner portions that allow the interior-side sealing lips and the exterior-side sealing lip to fall down to a direction of the inner side surface of the interior-side side wall and a direction of the inner side surface of the exterior-side side wall respectively.

According to the present invention, it is possible to obtain the smooth sliding characteristic (the smooth ascent-descent characteristic) of the door glass while suppressing the occurrence of an unusual noise due to the rattle caused by shake or vibration of the door glass when closing the door or during travel at high speed in the state in which the door glass is slightly open.

The other objects and features of the present invention will become understood from the following description with reference to the accompanying drawings.

### BRIEF DESCRIPTION OF THE DRAWINGS

FIG. 1 is a side view of a vehicle front door to which a glass run according to embodiments of the present invention is fixed.

FIG. 2 is a simplified front view of the glass run alone of a first embodiment, viewed from a vehicle exterior side.

FIG. 3 is a sectional view taken along an A-A line of a rear-side longitudinal frame portion of a sash of FIG. 1.

FIG. 4 is a sectional view showing a state in which the door glass comes into an inside of the glass run of the present embodiment.

FIG. 5 is a sectional view showing contact positions of an exterior-side sealing lip and interior-side sealing lips to the door glass in a state in which the door glass coming into the inside of the glass run slightly shakes or vibrates in exterior and interior directions.

FIG. 6 is a sectional view showing a state in which the door glass coming into the inside of the glass run greatly shakes or vibrates and the exterior-side sealing lip and the interior-side sealing lips fall down or are bent the most.

FIG. 7 is characteristics of a reaction force to the door glass and fitting of the sealing lips with a tilt angle of the exterior-side sealing lip and the interior-side sealing lips being varied, obtained from a result of an experiment carried out by the inventor.

FIG. 8 is a sectional view of a glass run according to a second embodiment of the present invention.

FIG. 9 is a sectional view showing a state in which the door glass comes into an inside of the glass run of the present embodiment.

FIG. 10 is a sectional view showing contact positions of an exterior-side sealing lip and interior-side sealing lips to the door glass in a state in which the door glass coming into the inside of the glass run slightly shakes or vibrates in the exterior and interior directions.

FIG. 11 is a sectional view showing a state in which the door glass coming into the inside of the glass run greatly shakes or vibrates and the exterior-side sealing lip and the interior-side sealing lips fall down or are bent the most.

FIG. 12 is a sectional view of a conventional glass run.

### DETAILED DESCRIPTION OF THE INVENTION

Embodiments of a glass run according to the present invention will be described below with reference to the drawings. The present embodiment shows an example in which the glass run is fixed to a sash of a front door as a press door of a vehicle.

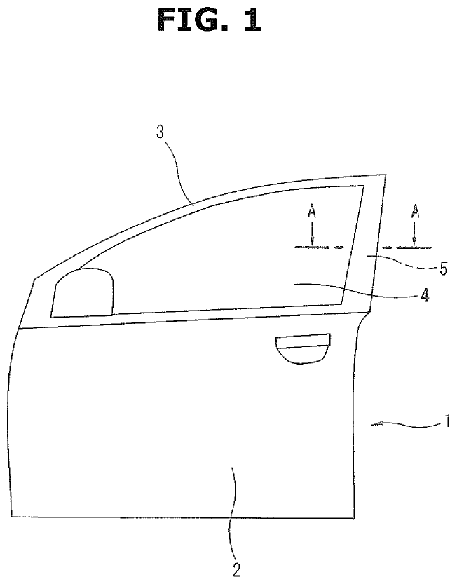

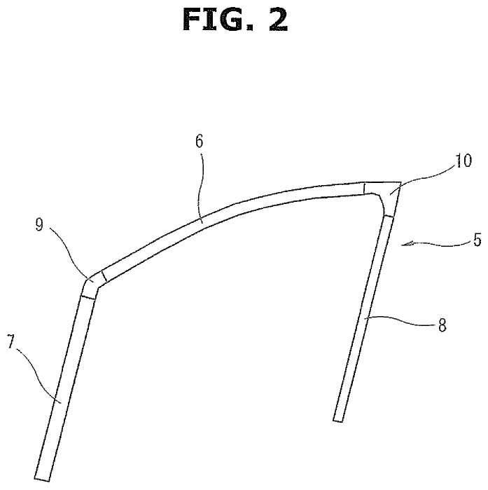

FIG. 1 is a side view of a vehicle front door to which the glass run according to the present embodiment is fixed. FIG. 2 is a simplified front view of the glass run alone of the present embodiment, viewed from a vehicle exterior side.

As illustrated in FIG. 1, a sash 3 formed by roll forming and having a substantially square bracket shape in cross section is provided at an upper end portion of a door body 2 of a left-side front door 1 of a vehicle. A window opening is formed by this sash 3 and an upper end edge of the door body 2. A glass run 5 that guides a door glass 4 to ascend and descend is fixed to an inner peripheral edge of the window opening and an inside of the door body 2. Here, the glass run of the present invention can be applied to not only the left-side front door 1 but a right-side front door (not shown) and right-side and left-side rear doors (not shown) as well.

As illustrated in FIG. 2, the glass run 5 according to the first embodiment is formed by a first extrusion molding portion 6 corresponding to a lateral frame portion of the sash 3, a second extrusion molding portion 7 corresponding to a longitudinal frame portion of the sash 3 at a front side of the front door 1 and a third extrusion molding portion 8 corresponding to a longitudinal frame portion of the sash 3 at a rear side of the front door 1. A front end portion of the first extrusion molding portion 6 and an upper end portion of the second extrusion molding portion 7 are connected by a first molding portion 9, and a rear end portion of the first extrusion molding portion 6 and an upper end portion of the third extrusion molding portion 8 are connected by a second molding portion 10.

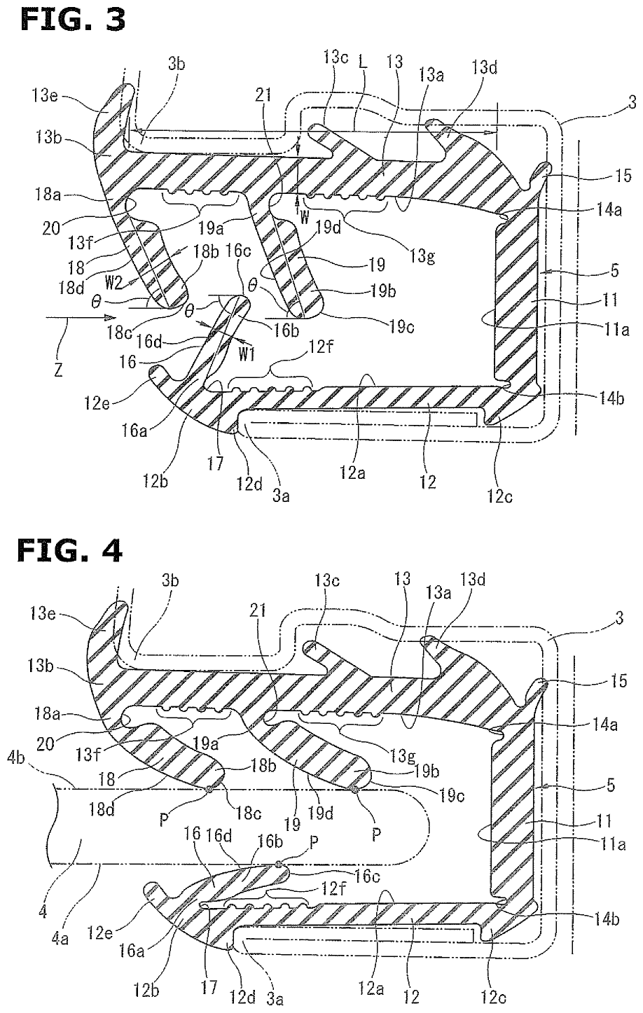

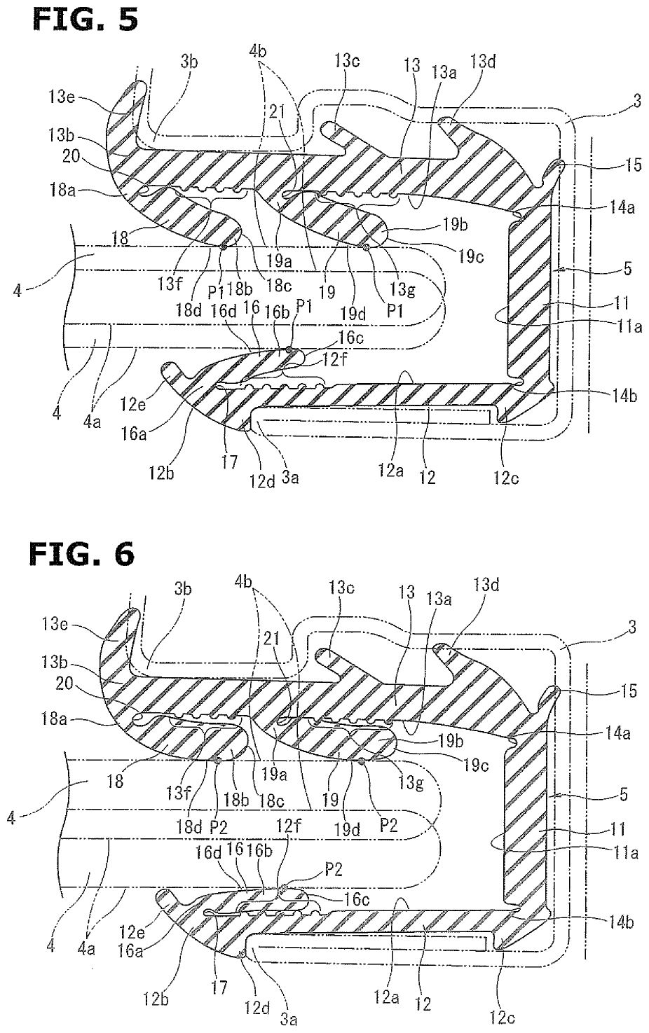

FIG. 3 is a sectional view taken along an A-A line of the rear side longitudinal frame portion of the sash 3 of FIG. 1. FIG. 4 is a sectional view showing a state in which the door glass 4 comes into an inside of the glass run 5. FIG. 5 is a sectional view showing contact positions of an exterior-side sealing lip 16 and interior-side sealing lips 18 and 19 to the door glass 4 in a state in which the door glass 4 coming into the inside of the glass run 5 slightly shakes or vibrates in exterior and interior directions. FIG. 6 is a sectional view showing a state in which the door glass 4 coming into the inside of the glass run 5 greatly shakes or vibrates and the exterior-side sealing lip 16 and the interior-side sealing lips 18 and 19 fall down or are bent the most.

As illustrated in FIGS. 3 and 4, the glass run 5 is formed into a substantially square bracket shape (a channel shape) in cross section with thermoplastic vulcanizate (TPV). The glass run 5 has a flat plate-shaped bottom wall 11, an exterior-side side wall 12 and an interior-side side wall 13 which are connected to both end portions, in a width direction, of the bottom wall 11. A pair of groove portions 14a and 14b, through which the interior-side side wall 13 and the exterior-side side wall 12 can be developed in a free state, are formed at inner sides of connecting portions between the both end portions, in the width direction, of the bottom wall 11 and the interior-side side wall 13 and the exterior-side side wall 12. The interior-side side wall 13 is formed so that its width direction length L and its thickness W are greater than those of the exterior-side side wall 12, then the interior-side side wall 13 and the exterior-side side wall 12 are asymmetrical.

The bottom wall 11 has a substantially flat inner bottom surface 11a that is a contact surface to the door glass 4. The bottom wall 11 is also provided, at an outer surface of the connecting portion with the interior-side side wall 13, with a lip portion 15 which protrudes from the outer surface of the connecting portion, elastically contacts an inner surface of the sash 3 and seals a gap between the sash 3 and the bottom wall 11.

The exterior-side side wall 12 is provided, at its top end portion 12b located at an opposite side to the bottom wall 11 in the width direction, with one exterior-side sealing lip 16 formed integrally with the exterior-side side wall 12. This exterior-side sealing lip 16 has a relatively large thickness W1, and protrudes linearly. In a free state shown in FIG. 3 in which the exterior-side sealing lip 16 is not in contact with one side surface 4a of the door glass 4, the exterior-side sealing lip 16 stands up toward an inner side surface 13a of the interior-side side wall 13 in a direction of the bottom wall 11, and obliquely protrudes from the top end portion 12b. In the free state, a tilt angle (or an oblique angle) θ of the exterior-side sealing lip 16 is set to within a range of 65 to 75 degrees with an incoming direction line Z of the door glass 4 being a reference. In the present embodiment, the tilt angle θ is set to substantially 70 degrees.

The exterior-side sealing lip 16 has a top end surface 16c formed so as to have a radius of curvature of a small arc-shaped surface.

Further, at a base end portion 16a of the exterior-side sealing lip 16, a notch portion 17 as a thinner portion for allowing the exterior-side sealing lip 16 to fall down or bend to a direction of the exterior-side side wall 12 by a pressing force transmitted from the one side surface 4a of the door glass 4 when the door glass 4 ascends or descends is formed.

A contact surface 16d of the exterior-side sealing lip 16, which extends from a position opposite to a forming position of the notch portion 17 of the base end portion 16a to a direction of the top end surface 16c of a top end portion 16b of the exterior-side sealing lip 16 and which can contact the one side surface 4a of the door glass 4, is formed into an arc shape along its extending direction. This arc-shaped contact surface 16d contacts the one side surface 4a of the door glass 4 in a line-contact state, and in the present embodiment, its radius of curvature is set to substantially 40R. Here, 40R indicates that a radius is 40 mm. Grounds for specific numerical value of the radius of curvature are based on an after-mentioned experimental result by the inventor.

The exterior-side side wall 12 is provided, on an outer surface of its connecting portion with the one end portion of the bottom wall 11, with a first holding protruding portion 12c that is in contact with the inner surface of the sash 3 and is held by this inner surface of the sash 3. The exterior-side side wall 12 is also provided, on an outer surface of the top end portion 12b, with a second holding protruding portion 12d that is fitted to a top end portion 3a of one side wall, which is bent so as to fold back, of the sash 3 and is held by this top end portion 3a of the sash 3. The exterior-side side wall 12 is further provided, on an inner surface of the top end portion 12b, with a supporting lip 12e that contacts and supports the one side surface 4a of the door glass 4 when the door glass 4 excessively moves in the vehicle exterior direction. In addition, on an inner side surface 12a of the exterior-side side wall 12, corrugated protrusions 12f which the exterior-side sealing lip 16 contacts when the exterior-side sealing lip 16 excessively falls down or is bent to a direction of the inner side surface 12a by a pressing force of the door glass 4 are formed.

As illustrated in FIGS. 3 and 4, the interior-side side wall 13 is provided, at its top end portion 13b located at an opposite side to the bottom wall 11 in the width direction and at a predetermined position of the inner side surface 13a of the interior-side side wall 13, with the two interior-side sealing lips 18 and 19. These two interior-side sealing lips 18 and 19 have substantially the same thickness W2, which is greater than the thickness W1 of the exterior-side sealing lip 16, then rigidity of the interior-side sealing lips 18 and 19 is further increased. The interior-side sealing lips 18 and 19 are formed linearly, and in a free state in which the interior-side sealing lips 18 and 19 are not in contact with the other side surface 4b of the door glass 4, the interior-side sealing lips 18 and 19 stand up toward the inner side surface 12a of the exterior-side side wall 12 in a direction of the bottom wall 11, and obliquely protrude from the top end portion 13b and the predetermined position of the inner side surface 13a respectively. In the same manner as the exterior-side sealing lip 16, in the free state shown in FIG. 3, tilt angles (or oblique angles) θ and θ of the interior-side sealing lips 18 and 19 are set to within a range of 65 to 75 degrees with the incoming direction line Z of the door glass 4 being a reference. In the present embodiment, the tilt angles θ and θ are set to substantially 70 degrees.

The interior-side sealing lips 18 and 19 have top end portions 18b and 19b having top end surfaces 18c and 19c respectively formed so as to have a radius of curvature of a small arc-shaped surface.

Further, at base end portions 18a and 19a of the interior-side sealing lips 18 and 19, two notch portions 20 and 21 as thinner portions for allowing the interior-side sealing lips 18 and 19 to fall down or bend to a direction of the inner side surface 13a of the interior-side side wall 13 by a pressing force transmitted from the other side surface 4b of the door glass 4 when the door glass 4 comes into the inside of the glass run 5 are formed.

Contact surfaces 18d and 19d of the interior-side sealing lips 18 and 19, which extend from positions opposite to forming positions of the notch portions 20 and 21 of the base end portions 18a and 19a to directions of the top end surfaces 18c and 19c of the top end portions 18b and 19b of the interior-side sealing lips 18 and 19 and which can contact the other side surface 4b of the door glass 4, are formed into an arc shape along their extending directions. Each of these contact surfaces 18d and 19d contacts the other side surface 4b of the door glass 4 in a line-contact state. In the same manner as the contact surface 16d of the exterior-side sealing lip 16, their radii of curvature are set to substantially 40R. As mentioned above, 40R indicates that a radius is 40 mm.

Further, as illustrated in FIG. 6, the interior-side sealing lips 18 and 19 are arranged at separate positions where the interior-side sealing lips 18 and 19 do not interfere with each other even when the interior-side sealing lips 18 and 19 fall down or are bent to the inner side surface 13a side by the excessive pressing force from the other side surface 4b of the door glass 4.

The interior-side side wall 13 is provided, at a position close to the other end portion of the bottom wall 11 and a position located on the top end portion 13b side with respect to this close position on an outer surface of the interior-side side wall 13, with two holding lips 13d and 13c that protrude from the respective positions and are in contact with the inner surface of the sash 3. The interior-side side wall 13 is further provided, on an outer surface of the top end portion 13b, with an engaging lip 13e that is engaged with a bending end portion 3b of the other side wall of the sash 3. In addition, on the inner side surface 13a of the interior-side side wall 13, corrugated protrusions 13f and 13g which the interior-side sealing lips 18 and 19 contact respectively when the interior-side sealing lips 18 and 19 excessively fall down or are bent to a direction of the inner side surface 13a by a pressing force of the door glass 4 are formed.

The reason why the tilt angles θ of the exterior-side sealing lip 16 and the interior-side sealing lips 18 and 19 are set to substantially 70 degrees will be described in detail in the following description of “Working and Effect”.

### Working and Effect of Glass Run of the Present Embodiment

Working and effect of the glass run 5 of the present embodiment will be described with reference to FIGS. 4 to 7.

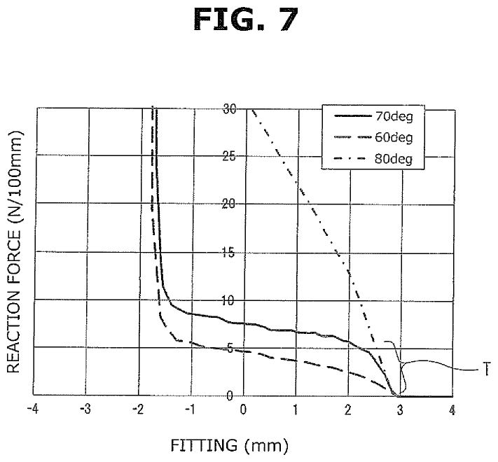

FIG. 7 is characteristics of a reaction force (a pressing force) to the door glass and fitting of the sealing lips with a tilt angle of the exterior-side sealing lip and the interior-side sealing lips being varied, obtained from a result of an experiment carried out by the inventor.

According to the glass run 5 of the present embodiment, as illustrated in FIG. 4, the one side surface 4a and the other side surface 4b of the door glass 4 coming into the inside of the glass run 5 are slidably supported by the one exterior-side sealing lip 16 and the two interior-side sealing lips 18 and 19. In particular, the exterior-side sealing lip 16 and the interior-side sealing lips 18 and 19 are formed linearly, and are in contact with the one side surface 4a and the other side surface 4b of the door glass 4 then support the door glass 4 in the state of the line-contact of the top end surfaces 16c, 18c and 19c of the top end portions 16b, 18b and 19b and also in a state in which the top end surfaces 16c, 18c and 19c (the top end portions 16b, 18b and 19b) stretch or straighten without the top end portions 16b, 18b and 19b being deformed or curved.

Therefore, when the door glass 4 shakes or vibrates which is caused by the closing of the door or by a pressure difference between vehicle interior and exterior during travel at high speed in a half-open state of the door glass 4, kinetic energy by movement of the door glass 4 in exterior and interior directions due to this vibration can be effectively absorbed by each of the sealing lips 16, 18 and 19. As a result, an occurrence of an unusual noise caused by the rattle of the door glass 4 can be suppressed.

Further, the arc-shaped top end surfaces 16c, 18c and 19c of the sealing lips 16, 18 and 19 do not slide by surface-contact like the conventional glass run of the Patent Document 2, but slide on the both side surfaces 4a and 4b of the ascending/descending door glass 4 in the line-contact state. Therefore, a sliding friction drag (or a frictional resistance) becomes small, and a smooth sliding characteristic of the door glass 4 can be obtained.

Setting of the tilt angles of the exterior-side sealing lip 16 and the interior-side sealing lips 18 and 19 in the free state was derived from the result of the experiment carried out with the tilt angle θ being varied by the inventor, as shown in FIG. 7.

That is, in a case where the tilt angle θ of each of the sealing lips 16, 18 and 19 is set to substantially 60 degrees, as shown by a broken line in FIG. 7, rising of the pressing force that is the reaction force at the beginning of slide (the beginning T of contact) of the top end portions 16b, 18b and 19b on (with) the both side surfaces 4a and 4b of the door glass 4 becomes low. Because of this, water-tightness with the door glass 4, i.e. a sealing performance, is impaired, then there is a risk that water leak will occur. Further, the pressing force by each of the sealing lips 16, 18 and 19 after the beginning of slide (the beginning T of contact) also does not become large and is still in a relatively low state. Therefore, it was found that a force absorbing the reaction force of the rattle of the door glass 4 was small (weak), and this rattle cannot be effectively suppressed.

In a case where the tilt angle θ of each of the sealing lips 16, 18 and 19 is set to substantially 80 degrees, as shown by a dashed line in FIG. 7, by a large angle of each of the sealing lips 16, 18 and 19, the pressing force at the beginning T of slide of the top end portions 16b, 18b and 19b on the both side surfaces 4a and 4b of the door glass 4 rises steeply. Therefore, although the sealing performance between the sealing lips 16, 18 and 19 and the door glass 4 by the sealing lips 16, 18 and 19 can be secured, a high pressing force of each of the sealing lips 16, 18 and 19 to the door glass 4 is maintained even after the beginning T of slide. Because of this, the sliding friction drag (or the frictional resistance) between each of the sealing lips 16, 18 and 19 and the door glass 4 becomes excessively large, then the smooth sliding characteristic of the door glass 4 when the door glass 4 ascends or descends cannot be obtained.

In a case where the tilt angle θ of each of the sealing lips 16, 18 and 19 is set to substantially 70 degrees, as shown by a solid line in FIG. 7, similar to the case where the tilt angle θ is set to substantially 80 degrees, rising of the pressing force at the beginning T of slide of the top end portions 16b, 18b and 19b on the both side surfaces 4a and 4b of the door glass 4 becomes high. Therefore, the sealing performance between the sealing lips 16, 18 and 19 and the door glass 4 by the sealing lips 16, 18 and 19 can be secured. After the beginning T of slide, since the pressing force of each of the sealing lips 16, 18 and 19 becomes low and substantially flat, the sliding friction drag (or the frictional resistance) between the top end portions 16b, 18b and 19b of the sealing lips 16, 18 and 19 and the both side surfaces 4a and 4b of the door glass 4 becomes small, then the smooth sliding characteristic of the door glass 4 can be obtained. It is noted that even in a case where the tilt angle was set to angles in the neighborhood of this 70 degrees, substantially the same result was obtained.

Accordingly, in the present invention, the tilt angle of each of the sealing lips 16, 18 and 19 is set to within the range of 65 to 75 degrees. In the present embodiment, the tilt angle is set to substantially 70 degrees.

Further, the reason why the radii of curvature of the arc-shaped contact surfaces 16d, 18d and 19d of the sealing lips 16, 18 and 19 are set to substantially 40R as described above is because, also from the experiment by the inventor, seal points (positions P in FIG. 4) as contact positions of the top end surfaces 16c, 18c and 19c of the sealing lips 16, 18 and 19 to the both side surfaces 4a and 4b of the door glass 4 in the beginning state are prevented from moving widely due to the vibration of the door glass 4.

That is, as illustrated in FIG. 4, in the beginning state in which the door glass 4 comes into the inside of the glass run 5 in the direction of the bottom wall 11 and the top end surfaces 16c, 18c and 19c of the exterior-side sealing lip 16 and the interior-side sealing lips 18 and 19 come into contact with the both side surfaces 4a and 4b of the door glass 4 in the line-contact state, the seal points P are within respective areas or regions of the top end surfaces 16c, 18c and 19c.

From this state, when giving vibration to the door glass 4 and seeing the seal points of the exterior-side sealing lip 16 and the interior-side sealing lips 18 and 19 with respect to the both side surfaces 4a and 4b of the door glass 4, it was found that, as shown in FIG. 5, although seal points P1 slightly moved to the contact surfaces 16d, 18d and 19d sides respectively with respect to the seal points P of the beginning state, positions of the seal points P1 were almost the same positions as the seal points P of the beginning state.

In contrast to this, when setting the radii of curvature of the contact surfaces 16d, 18d and 19d to a value far away from 40R, i.e. a value that is smaller or greater than a range of 35R to 45R, it was found that when the door glass 4 vibrates in the exterior and interior directions, the seal points P widely moved in directions of the respective base end portions 16a, 18a and 19a of the sealing lips 16, 18 and 19 or the contact surfaces 16d, 18d and 19d came into contact with the both side surfaces 4a and 4b of the door glass 4 in flat shape.

If the seal points P widely move in this way, pressing force characteristics with respect to the door glass 4 change, then there is a risk that the sealing performance by the sealing lips 16, 18 and 19 will become unstable.

When each radius of curvature is set to substantially 40R, as illustrated in FIG. 5, although the seal points P1 slightly move from the seal points P of the top end surfaces 16c, 18c and 19c of the beginning state, the seal points P1 do not widely move, and positions of the seal points P1 are almost the same positions as the seal points P of the beginning state.

Further, as illustrated in FIG. 6, in a state in which the door glass 4 greatly shakes or vibrates and the sealing lips 16, 18 and 19 fall down or are bent the most, although the contact surfaces 16d, 18d and 19d come into contact with the both side surfaces 4a and 4b of the door glass 4, their seal points P2 only slightly move to the directions of the respective base end portions 16a, 18a and 19a of the sealing lips 16, 18 and 19 from the seal points P of the beginning state.

Accordingly, in the present embodiment, the radii of curvature of the contact surfaces 16d, 18d and 19d are set to substantially 40R. With this setting, good and stable sealing performance between the sealing lips 16, 18 and 19 and the both side surfaces 4a and 4b of the door glass 4 by the sealing lips 16, 18 and 19 can be obtained.

In addition, as illustrated in FIG. 6, the interior-side sealing lips 18 and 19 do not interfere with each other even if the interior-side sealing lips 18 and 19 fall down or are bent to the inner side surface 13a side of the interior-side side wall 13 through the notch portions 20 and 21 when the top end portions 18b and 19b come into sliding-contact with the other side surface 4b of the door glass 4 due to the vibration of the door glass 4. Therefore, each contact reaction force to the door glass 4 does not change. With this, smooth and stable sliding characteristic of the door glass 4 when the door glass 4 ascends or descends can be secured.

In other words, if the interior-side sealing lips 18 and 19 interfere with each other so that the top end portion 18b, located at the top end portion 13b side (a lower side), of the interior-side sealing lip 18 overlaps the upper-side interior-side sealing lip 19 when the interior-side sealing lips 18 and 19 fall down or are bent to the inner side surface 13a side of the interior-side side wall 13, the pressing force (the reaction force) of the lower-side interior-side sealing lip 18 to the door glass 4 becomes excessively large, then there is a risk that the smooth sliding characteristic of the door glass 4 when the door glass 4 ascends or descends cannot be obtained. Also, because the interior-side sealing lips 18 and 19 overlap each other, there is a risk that a range of movement of the door glass 4 to the vehicle interior side cannot be sufficiently secured.

However, in the present embodiment, since the lower-side interior-side sealing lip 18 does not interfere with the upper-side interior-side sealing lip 19 then the reaction force to the door glass 4 does not become large, not only the smooth and stable sliding characteristic of the door glass 4 when the door glass 4 ascends or descends can be secured, but also the range of movement of the door glass 4 to the vehicle interior side can become large.

Further, in the present embodiment, the corrugated protrusions 12f, 13f and 13g are formed on the inner side surface 12a of the exterior-side side wall 12 and the inner side surface 13a of the interior-side side wall 13. Therefore, as illustrated in FIG. 6, when the exterior-side sealing lip 16 and the interior-side sealing lips 18 and 19 excessively move to the vehicle exterior side and to the vehicle interior side by the pressing force of the door glass 4 due to the vibration of the door glass 4 and fall down or are bent to the inner side surface 12a side and to the inner side surface 13a side, the exterior-side sealing lip 16 and the interior-side sealing lips 18 and 19 come into contact with the corrugated protrusions 12f, 13f and 13g. Therefore, the exterior-side sealing lip 16 and the interior-side sealing lips 18 and 19 do not come into absolute contact with the inner side surfaces 12a and 13a, but can quickly separate from the inner side surfaces 12a and 13a. An occurrence of sticking and unsticking noises of the sealing lips 16, 18 and 19 to and from the inner side surfaces 12a and 13a can thus be suppressed, and returning performance of the sealing lips 16, 18 and 19 to their original positions is improved. Hence, the sealing performance and quietness of the sealing lips 16, 18 and 19 by quick contact to the door glass 4 are improved.

### Second Embodiment

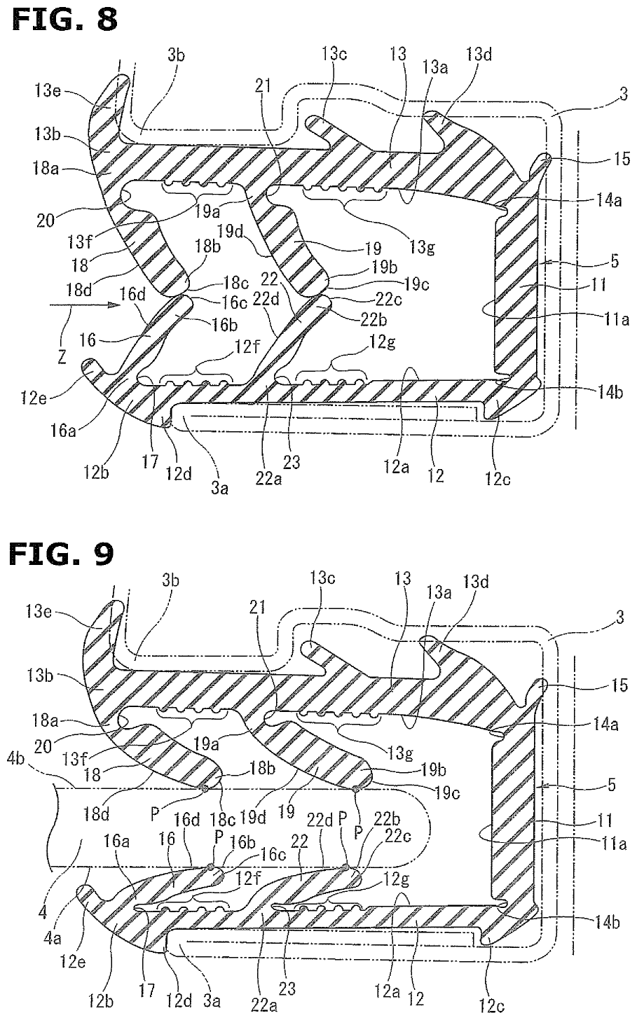

FIGS. 8 to 11 show a second embodiment of the present invention. A basic structure or configuration of the second embodiment is the same as that of the first embodiment. As a different point, one exterior-side sealing lip is added, then two exterior-side sealing lips are provided.

That is, as illustrated in FIGS. 8 and 9, in addition to the exterior-side sealing lip 16 at the top end portion 12b side of the exterior-side side wall 12, a second exterior-side sealing lip 22 is provided at a predetermined position on the inner side surface 12a of the exterior-side side wall 12, i.e. at a position facing the second interior-side sealing lip 19 provided on the inner side surface 13a of the interior-side side wall 13.

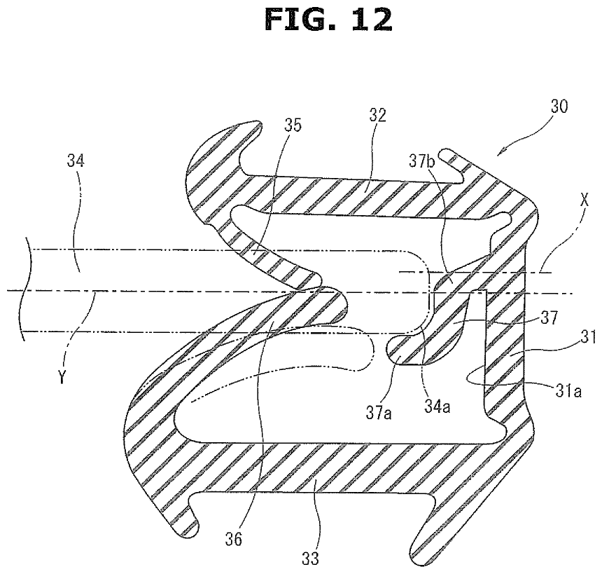

This second exterior-side sealing lip 22 has the same shape and size (dimensions) as those of the first exterior-side sealing lip 16. Further, in the same manner as the exterior-side sealing lip 16, the second exterior-side sealing lip 22 has a structure in which second exterior-side sealing lip 22 is provided at the substantially 70-degree tilt angle, and a top end surface 22c of a top end portion 22b is formed into an arc shape. Furthermore, a contact surface 22d of the second exterior-side sealing lip 22 is formed into an arc shape, and its radius of curvature is the same as that of the first exterior-side sealing lip 16. Moreover, as illustrated in FIG. 11, the second exterior-side sealing lip 22 is formed at a position where the second exterior-side sealing lip 22 does not interfere with the first exterior-side sealing lip 16 even when the second exterior-side sealing lip 22 falls down or is bent to the inner side surface 12a side through a notch portion 23 as a thinner portion provided at a base end portion 22a of the second exterior-side sealing lip 22 when the door glass 4 shakes or vibrates.

In addition, on the inner side surface 12a of the exterior-side side wall 12, corrugated protrusions 12g which the second exterior-side sealing lip 22 can contact are formed.

In this second embodiment, by adding the second exterior-side sealing lip 22, the sealing performance between the exterior-side sealing lips 16 and 22 and the door glass 4 by exterior-side sealing lips 16 and 22 is further improved. Further, kinetic energy by movement of the door glass 4 to the vehicle exterior side when closing the door or during travel at high speed in the half-open state of the door glass 4 can be received and absorbed by not only the first exterior-side sealing lip 16 but also the second exterior-side sealing lip 22 in the line-contact state and in the stretching (or straightening) state. Therefore, an occurrence of the rattle can be further effectively suppressed. As a result, an occurrence of an unusual noise caused by the rattle of the door glass 4 can be suppressed.

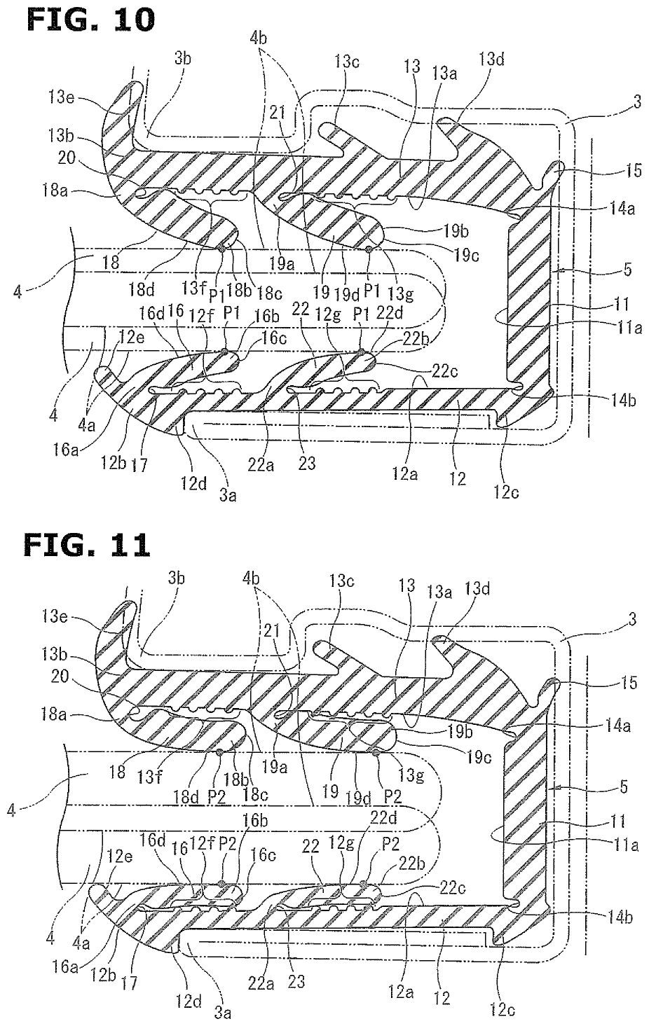

Further, since the radius of curvature of the arc-shaped contact surface 22d of the second exterior-side sealing lip 22 is also set to substantially 40R, as illustrated in FIG. 10, although a seal point P2 of the second exterior-side sealing lip 22 slightly moves from a seal point P of the top end surface 22c to the door glass 4 of the beginning state due to the vibration of the door glass 4, the seal point P2 does not widely move. Therefore, good and stable sealing performance between the sealing lips 16, 22, 18 and 19 and the both side surfaces 4a and 4b of the door glass 4 by the sealing lips 16, 22, 18 and 19 can be obtained.

In addition, as illustrated in FIG. 11, the exterior-side sealing lips 16 and 22 do not interfere with each other even if the exterior-side sealing lips 16 and 22 fall down or are bent to the inner side surface 12a side of the exterior-side side wall 12 through the notch portions 17 and 23 when the top end surfaces 16c and 22c of the top end portions 16b and 22b come into sliding-contact with the one side surface 4a of the door glass 4. Therefore, in the same manner as the interior-side sealing lips 18 and 19, each contact reaction force to the door glass 4 does not change. With this, smooth and stable sliding characteristic of the door glass 4 can be secured all the time, and a range of movement of the door glass 4 can be widened.

Since the other structure or configuration of the second embodiment is the same as that of the first embodiment, the same working and effect as those of the first embodiment can be obtained.

The present invention is not limited to the structure or configuration of the above embodiments. For instance, a sectional form of the glass run 5, i.e. sectional forms such as lengths of the bottom wall 11, the interior-side side wall 13 and the exterior-side side wall 12 in cross 1section, could be arbitrarily changed according to a shape or size of the vehicle. Further, the number of the exterior-side sealing lip 16 and the interior-side sealing lips 18 and 19 could be arbitrarily further increased.

From the foregoing, the present invention includes the following structures or configurations of the glass run, and has the following effects.

A glass run (5) comprising: a bottom wall (11); an interior-side side wall (13) and an exterior-side side wall (12) provided at both end edges in a wide direction of the bottom wall (11); at least two interior-side sealing lips (18, 19) provided on an inner side surface (13a) of the interior-side side wall (13) and obliquely protruding toward the exterior-side side wall (12); and an exterior-side sealing lip (16) provided on an inner side surface (12a) of the exterior-side side wall (12) and obliquely protruding toward the interior-side side wall (13), wherein both side surfaces (4a, 4b) of a door glass (4), which comes into the glass run (5) toward the bottom wall (11), are supported in a sliding-contact state by top end portions (18b, 19b) of the interior-side sealing lips (18, 19) and a top end portion (16b) of the exterior-side sealing lip (16), the interior-side sealing lips (18, 19) and the exterior-side sealing lip (16) are formed linearly toward the exterior-side side wall (12) and the interior-side side wall (13) respectively, top end surfaces (18c, 19c, 16c), each of which is formed into an arc shape in cross section, of the top end portions (18b, 19b, 16b) of the interior-side sealing lips (18, 19) and the exterior-side sealing lip (16) can slide on the both side surfaces (4a, 4b) of the door glass (4) in a line-contact state, and the interior-side sealing lips (18, 19) and the exterior-side sealing lip (16) are provided, at base end portions (18a, 19a, 16a) thereof connected to the interior-side side wall (13) and the exterior-side side wall (12) respectively, with respective thinner portions (20, 21, 17) that allow the interior-side sealing lips (18, 19) and the exterior-side sealing lip (16) to fall down to a direction of the inner side surface (13a) of the interior-side side wall (13) and a direction of the inner side surface (12a) of the exterior-side side wall (12) respectively.

According to the above structure of the glass run, the both side surfaces (4a, 4b) of the door glass (4) are supported by the exterior-side sealing lip (16) and, for instance, two interior-side sealing lips (18, 19). In particular, the exterior-side sealing lip (16) and the interior-side sealing lips (18, 19) are formed linearly, and are in contact with the both side surfaces (4a, 4b) of the door glass (4) respectively in the state of the line-contact of the top end surfaces (16c, 18c and 19c) of the top end portions (16b, 18b and 19b) and also in a state in which the top end surfaces (16c, 18c and 19c) (the top end portions (16b, 18b and 19b)) stretch or straighten without the top end portions (16b, 18b and 19b) being deformed or curved.

Therefore, when the door glass (4) shakes or vibrates which is caused by the closing of the door or by a pressure difference between vehicle interior and exterior during travel at high speed in a half-open state of the door glass (4), kinetic energy by movement of the door glass (4) in exterior and interior directions due to this vibration can be effectively absorbed by each of the sealing lips (16, 18 and 19). As a result, an occurrence of an unusual noise caused by the rattle of the door glass (4) can be suppressed.

Further, the top end surfaces (16c, 18c and 19c) of the exterior-side sealing lip (16) and the interior-side sealing lips (18, 19) slide on the both side surfaces (4a, 4b) of the door glass (4) respectively in the line-contact state. Therefore, a sliding friction drag (or a frictional resistance) becomes small, and a smooth sliding characteristic of the door glass (4) can be obtained.

Preferably, the interior-side sealing lips (18, 19) are provided at positions where the interior-side sealing lips (18, 19) do not interfere with each other when the interior-side sealing lips (18, 19) fall down to the direction of the interior-side side wall (13) through the thinner portions (20, 21) in a state in which the top end surfaces (18c, 19c) of the top end portions (18b, 19b) of the interior-side sealing lips (18, 19) are in contact with the side surface (4b) of the door glass (4).

Preferably, tilt angles (θ) of the interior-side sealing lips (18, 19) and the exterior-side sealing lip (16) at which the interior-side sealing lips (18, 19) and the exterior-side sealing lip (16) stand up from the inner side surface (13a) of the interior-side side wall (13) and the inner side surface (12a) of the exterior-side side wall (12) respectively in a free state in which the top end surfaces (18c, 19c, 16c) of the top end portions (18b, 19b, 16b) of the interior-side sealing lips (18, 19) and the exterior-side sealing lip (16) are not in contact with the both side surfaces (4a, 4b) of the door glass (4) are each set to within a range of 65 to 75 degrees with an incoming direction line (Z) of the door glass (4) being a reference.

Preferably, a contact surface (16d) of the exterior-side sealing lip (16), which extends from the base end portion (16a) of the exterior-side sealing lip (16) to a direction of the top end surface (16c) of the exterior-side sealing lip (16) and which can come into contact with the one side surface (4a) of the door glass (4), is formed into an arc shape along an extending direction of the contact surface (16d), and contact surfaces (18d, 19d) of the interior-side sealing lips (18, 19), which extend from the base end portions (18a, 19a) of the interior-side sealing lips (18, 19) to respective directions of the top end surfaces (18c, 19c) of the interior-side sealing lips (18, 19) and which can come into contact with the other side surface (4b) of the door glass (4), are formed into an arc shape along respective extending directions of the contact surfaces (18d, 19d).

Preferably, a radius of curvature of the arc-shaped contact surface (16d) of the exterior-side sealing lip (16) and radii of curvature of the arc-shaped contact surfaces (18d, 19d) of the interior-side sealing lips (18, 19) are each set to within a range of 35R to 45R.

Preferably, in addition to the exterior-side sealing lip (16), a second exterior-side sealing lip (22) is provided on the inner side surface (12a) of the exterior-side side wall (12), the second exterior-side sealing lip (22) has the same structure as that of the exterior-side sealing lip (16), and the exterior-side sealing lip (16) and the second exterior-side sealing lip (22) are provided at positions where these exterior-side sealing lip (16) and second exterior-side sealing lip (22) do not interfere with each other when the exterior-side sealing lip (16) and the second exterior-side sealing lip (22) fall down to the direction of the exterior-side side wall (12) through the thinner portion (17) provided at the base end portion (16a) of the exterior-side sealing lip (16) and a thinner portion (23) provided at a base end portion (22a) of the second exterior-side sealing lip (22) respectively in a state in which the top end surface (16c) of the top end portion (16b) of the exterior-side sealing lip (16) and a top end surface (22c) of a top end portion (22b) of the second exterior-side sealing lip (22) are in contact with the side surface (4a) of the door glass (4).

The entire contents of Japanese Patent Application No. 2022-159894 filed on Oct. 4, 2022 are incorporated herein by reference.

Although the invention has been described above by reference to certain embodiments of the invention, the invention is not limited to the embodiments described above. Modifications and variations of the embodiment described above will occur to those skilled in the art in light of the above teachings. The scope of the invention is defined with reference to the following claims.

### EXPLANATION OF REFERENCE

1 front door
2 door body
3 sash
4 door glass
5 glass run
11 bottom wall
11a inner bottom surface
12 exterior-side side wall
12a inner side surface
12b top end portion
13 interior-side side wall
13a inner side surface
13b top end portion
16 first exterior-side sealing lip
16a base end portion
16b top end portion
16c top end surface
16d contact surface
17 notch portion (thinner portion)
18 first interior-side sealing lip
18a base end portion
18b top end portion
18c top end surface
18d contact surface
19 second interior-side sealing lip
19a base end portion
19b top end portion
19c top end surface
19d contact surface
20, 21 notch portion (thinner portion)
22 second exterior-side sealing lip
22a base end portion
22b top end portion
22c top end surface
22d contact surface,
P, P1, P2 seal point

What is claimed is:

1. A glass run comprising:
a bottom wall;
an interior-side side wall and an exterior-side side wall provided at both end edges in a wide direction of the bottom wall;
at least two interior-side sealing lips provided on an inner side surface of the interior-side side wall and obliquely protruding toward the exterior-side side wall; and
an exterior-side sealing lip provided on an inner side surface of the exterior-side side wall and obliquely protruding toward the interior-side side wall,
wherein both side surfaces of a door glass, which comes into the glass run toward the bottom wall, are supported in a sliding-contact state by top end portions of the interior-side sealing lips and a top end portion of the exterior-side sealing lip,
the interior-side sealing lips and the exterior-side sealing lip are formed linearly toward the exterior-side side wall and the interior-side side wall respectively,
top end surfaces, each of which is formed into an arc shape in cross section, of the top end portions of the interior-side sealing lips and the exterior-side sealing lip can slide on the both side surfaces of the door glass in a line-contact state, and
the interior-side sealing lips and the exterior-side sealing lip are provided, at base end portions thereof connected to the interior-side side wall and the exterior-side side wall respectively, with respective thinner portions that allow the interior-side sealing lips and the exterior-side sealing lip to fall down to a direction of the inner side surface of the interior-side side wall and a direction of the inner side surface of the exterior-side side wall respectively.

2. The glass run as claimed in claim 1, wherein
the interior-side sealing lips are provided at positions where the interior-side sealing lips do not interfere with each other when the interior-side sealing lips fall down to the direction of the interior-side side wall through the thinner portions in a state in which the top end surfaces of the top end portions of the interior-side sealing lips are in contact with the side surface of the door glass.

3. The glass run as claimed in claim 1, wherein
tilt angles of the interior-side sealing lips and the exterior-side sealing lip at which the interior-side sealing lips and the exterior-side sealing lip stand up from the inner side surface of the interior-side side wall and the inner side surface of the exterior-side side wall respectively in a free state in which the top end surfaces of the top end portions of the interior-side sealing lips and the exterior-side sealing lip are not in contact with the both side surfaces of the door glass are each set to within a range of 65 to 75 degrees with an incoming direction line of the door glass being a reference.

4. The glass run as claimed in claim 1, wherein
a contact surface of the exterior-side sealing lip, which extends from the base end portion of the exterior-side sealing lip to a direction of the top end surface of the exterior-side sealing lip and which can come into contact with the one side surface of the door glass, is formed into an arc shape along an extending direction of the contact surface, and
contact surfaces of the interior-side sealing lips, which extend from the base end portions of the interior-side sealing lips to respective directions of the top end surfaces of the interior-side sealing lips and which can come into contact with the other side surface of the door glass, are formed into an arc shape along respective extending directions of the contact surfaces.

5. The glass run as claimed in claim 4, wherein
a radius of curvature of the arc-shaped contact surface of the exterior-side sealing lip and radii of curvature of the arc-shaped contact surfaces of the interior-side sealing lips are each set to within a range of 35R to 45R.

6. The glass run as claimed in claim 1, wherein
in addition to the exterior-side sealing lip, a second exterior-side sealing lip is provided on the inner side surface of the exterior-side side wall,
the second exterior-side sealing lip has the same structure as that of the exterior-side sealing lip, and
the exterior-side sealing lip and the second exterior-side sealing lip are provided at positions where these exterior-side sealing lip and second exterior-side sealing lip do not interfere with each other when the exterior-side sealing lip and the second exterior-side sealing lip fall down to the direction of the exterior-side side wall through the thinner portion provided at the base end portion of the exterior-side sealing lip and a thinner portion provided at a base end portion of the second exterior-side sealing lip respectively in a state in which the top end surface of the top end portion of the exterior-side sealing lip and a top end surface of a top end portion of the second exterior-side sealing lip are in contact with the side surface of the door glass.
